(19) United States
(12) Patent Application Publication
(10) Pub. No.: US 2026/0010689 A1
(43) Pub. Date: Jan. 8, 2026

(54) System and method for networked digital twins

(71) Applicant: BLUMEx Inc., Markham (CA)

(72) Inventor: Ravi Ravindran, Markham (CA)

(73) Assignee: BLUMEx Inc., Markham (CA)

(21) Appl. No.: 19/261,715

(22) Filed: Jul. 7, 2025

Related U.S. Application Data
(60) Provisional application No. 63/667,939, filed on Jul. 5, 2024.

(51) Int. Cl. G06F 30/27; G06F 9/50; H04L 9/40

(52) U.S. Cl. CPC G06F 30/27; G06F 9/5072; H04L 63/0428

(57) ABSTRACT

The various embodiments herein provide a system and method for networked digital twins with autonomous collaborative decision-making. The system comprises a Digital Twin Engine for real-time data acquisition, model synthesis, and simulation, an AI Module for advanced data analysis, an autonomous collaborative decision-making module for optimized decision-making, a communication layer for secure data exchange, and supporting modules for coordination, storage, security, and user interaction. The method for generating and deploying digital twins comprises data collection, transmission, preprocessing, model synthesis, simulation, validation, and deployment. The method for networking and collaboration comprises AI-based data processing, complex event processing, autonomous decision-making, task distribution, decision communication, real-time monitoring, and continuous improvement. This system enhances operational efficiency, scalability, and security, reducing the need for human intervention and providing a comprehensive management solution for complex systems.

### CROSS-REFERENCE TO RELATED APPLICATIONS

The embodiments herein claim the priority of the U.S. Provisional Patent Application filed on Jul. 5, 2024, with the No. 63/667,939 and titled, “SYSTEM AND METHOD FOR NETWORKED DIGITAL TWINS”, the contents of which are incorporated herein by the way of reference.

### BACKGROUND

### Description of the Related Art

The embodiments herein are generally related to digital twin technology. The embodiments herein are particularly related to networked digital twins. The embodiments herein are more particularly related to a system and method for networked digital twins with autonomous collaborative decision-making.

### Description of the Related Art

The current state of the art in digital twin technology primarily involves creating virtual replicas of physical assets for monitoring, maintenance, and optimization. These systems are widely used in manufacturing, heavy industries, and other fields where real-time data from physical entities is crucial. However, these traditional systems face significant challenges due to their isolated operation. They typically focus on individual assets without interconnectivity or the ability to collaborate with other digital twins. This isolation limits their effectiveness in complex environments where multiple systems need to interact.

Moreover, existing digital twin technologies struggle with efficiently handling real-time data. While they can process sensor data to predict equipment failures or schedule maintenance, they often lack the capability to integrate complex real-time decision-making processes. These systems tend to be reactive rather than proactive, relying heavily on human intervention for critical decisions and operations management.

Additionally, the existing systems that do incorporate AI primarily focus on basic predictive analytics without fully exploiting its potential for autonomous operations and sophisticated event-driven decision-making.

Therefore, there exists a need for a system and method for networked digital twins with autonomous collaborative decision-making.

The abovementioned shortcomings, disadvantages and problems are addressed herein, which will be understood by reading and studying the following specification.

### Object of the Embodiments Herein

The primary object of the embodiments herein is to provide a system and method for networked digital twins with autonomous collaborative decision-making.

Another object of the embodiments herein is to enable autonomous collaborative decision-making within a network of digital twins.

Yet another object of the embodiments herein is to integrate Artificial Intelligence and Complex Event Processing (CEP) for real-time data analysis and decision-making.

Yet another object of the embodiments herein is to reduce reliance on human intervention in the management of complex systems.

Yet another object of the embodiments herein is to enhance real-time operational efficiency through autonomous decision-making.

Yet another object of the embodiments herein is to provide a scalable and modular architecture for easy integration and expansion.

Yet another object of the embodiments herein is to ensure robust security and compliance within the network of digital twins.

Yet another object of the embodiments herein is to facilitate secure and efficient data exchange between digital twins.

Yet another object of the embodiments herein is to support predictive modeling and historical data analysis.

Yet another object of the embodiments herein is to provide a user interface for monitoring and interacting with the system.

These and other objects and advantages of the embodiments herein will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The various embodiments herein provide a system and method for networked digital twins with autonomous collaborative decision-making.

According to one embodiment herein, the system for networked digital twins with autonomous collaborative decision-making comprises a digital twin engine that does real-time data acquisition, model synthesis, simulation, and analytics for each digital twin; a data processing module, an AI module, that integrates artificial intelligence with complex event processing to perform advanced data analysis and manage real-time events; an autonomous collaborative decision-making module synthesizes insights from the AI Module to make autonomous and optimized decisions; a communication layer ensures secure and efficient data exchange between digital twins; a central coordination module manages interactions, distributes tasks, and facilitates centralized decision support; a data storage and analysis module that archives data for historical analysis and supports predictive modeling; a security and compliance module that ensures system security, regulatory compliance, and adherence to industry-specific regulations, and a User Interface module that provides an interface for human operators to monitor and interact with the system. The Digital Twin Engine further comprises the Data Acquisition Module, the Model Synthesis Module, and the Simulation Module.

According to one embodiment herein, a method is provided for generating and deploying digital twins. The method comprises: Data collection from a plurality of sensors, strategically placed on physical entities, to capture critical data points relevant to the operation and condition to gather real-time operational data; Data Transmission to the Digital Twin Engine using secure communication protocols ensuring that the data is received in real-time, allowing for timely updates to the digital twin; Data Preprocessing, wherein the data is cleaned and prepared for integration into digital twin models; Model Synthesis, wherein the digital twin models are created and updated based on the physical system's architecture, functionalities, and interactions ensuring a holistic and systematic representation of the physical entities; Simulation and Validation, wherein simulations are performed using the digital twin models to validate their accuracy and functionality to reliably replicate the behavior of their physical counterparts under various operational conditions; and Deployment of Digital Twins, wherein the validated digital twins are deployed into the operational environment by integrating the digital twins with existing systems and infrastructure, ensuring seamless communication and coordination with the physical entities.

According to another embodiment herein, a method is provided for networking and collaboration of digital twins. The method comprises: AI-Based Data Processing, wherein the preprocessed data is processed using AI algorithms to identify patterns and generate predictive insights using advanced machine learning techniques; Complex Event Processing that analyzes extensive data across the network of digital twins to identify patterns and behaviors, and processes complex sequences of events in real-time for interpretation of multiple high-velocity data streams, facilitating immediate and context-aware responses; Autonomous collaborative decision-making that synthesizes insights from the AI module to make optimized decisions by combining real-time data, historical data, and predictive insights to provide a comprehensive view of the operational environment, and determining the best course of action to optimize operations at both the individual twin level and across the network; Task Distribution that dynamically allocates tasks and resources through the Central Coordination System ensuring efficient distribution of resources and coordination of activities based on current operational needs and system status; Communication of Decisions that securely transmits decisions and commands back to the digital twins; Real-Time Monitoring that monitors system performance, generates alerts, and interacts with the digital twins, and provides real-time data, alerts, and performance metrics, allowing operators to adjust settings and manage operations as needed; and Feedback Loop and Continuous Improvement that collects operational feedback to refine models and improve decision-making algorithms, ensuring a responsive system by enhancing its efficiency and effectiveness over time.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates the overall architecture of the system for networked digital twins with autonomous collaborative decision-making, according to one embodiment herein.

FIG. 2 illustrates a method for generating and deploying digital twins, according to one embodiment herein.

FIG. 3 illustrates a method for networking and collaboration of digital twins, according to one embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments herein provide a system and method for networked digital twins with autonomous collaborative decision-making.

According to one embodiment herein, a system is provided for networked digital twins with autonomous collaborative decision-making. The system comprises a Digital Twin Engine; a data processing module; an AI Module; an autonomous collaborative decision-making Module; a Communication Layer; a Central Coordination module; Data Storage and Analysis module; a Security and Compliance Module; and a User Interface module.

According to one embodiment herein, the Digital Twin Engine is responsible for managing real-time data acquisition, model synthesis, simulation, and analytics for each digital twin. This engine continuously gathers real-time data from sensors deployed on physical entities and uses this data to create and update virtual models. The Digital Twin Engine further comprises the Data Acquisition Module, the Model Synthesis Module, and the Simulation Module.

According to one embodiment herein, the Data Acquisition Module gathers real-time data from a plurality of sensors installed on the physical entities. This data is then transmitted securely to the Digital Twin Engine for further processing. The Model Synthesis Module creates comprehensive digital models that accurately reflect the architecture, functionalities, and interactions of the physical systems. The Simulation Module simulates the behavior of the physical entities based on the real-time data, providing valuable insights for analysis and decision-making.

According to one embodiment herein, the data processing module perform data processing to clean, normalize, and prepare data for further operations.

According to one embodiment herein, the AI Module integrates artificial intelligence with complex event processing to perform advanced data analysis and manage real-time events. The module applies machine learning algorithms to identify patterns, generate predictive insights, and extract actionable intelligence from the data. The module carries out complex event processing to manage and respond to real-time sequences of events by identifying significant patterns and dynamically reacting to them using predefined rules and scenarios.

According to one embodiment herein, the Autonomous Collaborative Decision-Making (ACDM) Module synthesizes insights from the AI Module to make autonomous, and optimized decisions. The module combines real-time data, historical data, and predictive insights to provide a comprehensive view of the operational environment. The module further aggregates individual and collective inputs from the network of digital twins and determines the best course of action to optimize operations both at the individual twin level and across the network.

According to one embodiment herein, the Communication Layer ensures secure and efficient data exchange between digital twins. It is configured to support a plurality of data transmission protocols to ensure reliable and secure communication and supports a plurality of interfaces to facilitate communication between different modules of the system.

According to one embodiment herein, the Central Coordination System manages interactions between digital twins, distributes tasks, and facilitates centralized decision support. The module dynamically allocates tasks and resources based on current operational needs and system status, while ensuring efficient distribution of resources across the network.

According to one embodiment herein, the Data Storage and Analysis module archives data for historical analysis and supports predictive modeling. This module includes a data repository for storing large volumes of data and an analytics engine that provides tools for historical data analysis and model improvement.

According to one embodiment herein, the Security and Compliance Module ensures system security, regulatory compliance, and adherence to industry-specific regulations.

According to one embodiment herein, the User Interface (UI) module provides an interface for human operators to monitor and interact with the system. The UI module displays real-time data, alerts, and performance metrics, while generating detailed reports using reporting tools and allowing for operator interventions as needed.

According to one embodiment herein, a method is provided for generating and deploying digital twins. The method begins with Data collection from a plurality of sensors, strategically placed on physical entities, to capture critical data points relevant to the operation and condition to gather real-time operational data. Transmission of the data to the Digital Twin Engine using secure communication protocols ensuring that the data is received in real-time, allowing for timely updates to the digital twin. Data Preprocessing, wherein the data is cleaned and prepared for integration into digital twin models. Model Synthesis, wherein the digital twin models are created and updated based on the physical system's architecture, functionalities, and interactions ensuring a holistic and systematic representation of the physical entities. Simulation and Validation process, wherein simulations are performed using the digital twin models to validate their accuracy and functionality to reliably replicate the behavior of their physical counterparts under various operational conditions. The validated digital twins are deployed into the operational environment by integrating the digital twins with existing systems and infrastructure, ensuring seamless communication and coordination with the physical entities.

According to another embodiment herein, a method is provided for networking and collaboration of digital twins. The method comprises AI-Based Data Processing, that is configured with AI algorithms to identify patterns and generate predictive insights using Advanced machine learning techniques, from the preprocessed data. Complex Event Processing analyzes extensive data across the network of digital twins to identify patterns and behaviors, and it processes a complex sequence of events in real-time for interpretation of a plurality of high-velocity data streams, facilitating immediate and context-aware responses. The Autonomous collaborative decision-making process then, synthesizes insights to make optimized decisions by combining real-time data, historical data, and predictive insights to provide a comprehensive view of the operational environment, and determining the best course of action to optimize operations at both the individual twin level and across the network. Task distribution process dynamically allocates tasks and resources through the Central Coordination System ensuring efficient distribution of resources and coordination of activities based on current operational needs and system status. The decisions and instructions are then securely communicated back to the digital twins. Real-Time Monitoring of the system performance, generates alerts, and interacts with the digital twins, and provides real-time data, alerts, and performance metrics, allowing operators to adjust settings and manage operations as needed. Feedback loop and continuous improvement process collects operational feedback to refine models and improve decision-making algorithms, ensuring and responsive system by enhancing its efficiency and effectiveness over time.

According to one embodiment herein, the system for networked digital twins with autonomous collaborative decision-making comprises a digital twin engine, which includes a processor and a memory that stores instructions. When executed, these instructions enable the digital twin engine to acquire real-time sensor data from a plurality of physical entities, synthesize digital models representing the architecture and operational parameters of the physical entities, and simulate their behavior under variable operating conditions. A data processing module, implemented by a processor, performs cleaning, normalization, and transformation of the acquired data for further analysis. An artificial intelligence (AI) module includes machine learning models and complex event processing engines. This module generates predictive insights and responds to real-time, high-velocity data streams by identifying relevant patterns and events.

According to one embodiment herein, an autonomous collaborative decision-making module receives insights from the AI module and computes optimized decisions for individual digital twins and for the overall network. A communication layer securely exchanges data and decisions among the digital twins and the other system components using encrypted protocols. A central coordination module includes a task scheduler and a resource allocator. It dynamically distributes tasks across the digital twin network based on real-time operational states. A data storage and analysis module includes a data repository and an analytics engine. It stores operational and historical data and supports predictive modeling based on long-term trends and behavior. A security and compliance module enforces role-based access controls, encrypts data in transit and at rest, ensures regulatory compliance, and maintains audit logs. A user interface module provides dashboards and reporting tools. It allows human operators to monitor system performance, receive alerts, interact with the digital twins, and execute supervisory control actions.

According to one embodiment herein, the digital twin engine includes a data acquisition submodule, which receives real-time sensor data streams from multiple physical sources. A model synthesis submodule constructs structured digital representations of the physical systems using predefined component hierarchies and dependency graphs. A simulation submodule simulates the behavior of the digital twins based on operational parameters and validates model accuracy under various test scenarios.

According to one embodiment herein, the data processing module includes logic for detecting outliers, aligning timestamps across sensor inputs, and mapping the cleaned data into machine-readable formats. The AI module includes a predictive engine trained on historical and real-time data to forecast operational events and a complex event processor that identifies meaningful event sequences across the network.

According to one embodiment herein, the autonomous collaborative decision-making module includes a federated logic engine that aggregates decisions from individual digital twins and computes globally optimized outcomes using a graph-based dependency model. The communication layer supports encrypted communication using one or more protocols including TLS, MQTT, WebSockets, and HTTPS. It authenticates communication endpoints and encrypts the transmitted payloads. The central coordination module maintains a registry of all active digital twins and a dynamic task prioritization queue. It assigns tasks based on the availability, performance, and status of each digital twin.

According to one embodiment herein, the data storage and analysis module supports structured and unstructured data ingestion. It uses a time-series database and a distributed file system for long-term storage and supports analytics for refining models and improving decision accuracy. The security and compliance module logs system activity, detects potential intrusions, and verifies compliance with standards such as ISO 27001 and GDPR. The user interface module displays real-time status, visualizes system models and alerts, and provides operators with tools to override decisions and modify system parameters.

According to one embodiment herein, a computer-implemented method operates networked digital twins with autonomous collaborative decision-making. The method comprises collecting real-time operational data from a plurality of sensors embedded on physical systems. The system transmits the collected data to the digital twin engine through a secure communication channel. The data processing module preprocesses the data by removing noise, aligning time indices, and converting the data into a normalized structure.

According to one embodiment herein, the model synthesis submodule generates digital twin models that represent the structure and function of the physical systems. The simulation submodule simulates operational behavior and validates the models under a range of test scenarios. The AI module analyzes the preprocessed data using machine learning and complex event processing techniques to extract actionable insights. The autonomous collaborative decision-making module computes optimized decisions based on these insights, considering both local and global network objectives.

According to one embodiment herein, the central coordination module allocates operational tasks and system resources across the digital twin network. The communication layer transmits the computed decisions and commands to the respective digital twins. The user interface module monitors real-time system performance and visualizes key performance indicators, alerts, and interaction points. The data storage and analysis module stores operational feedback, updates model parameters, and retrains the AI models using the collected data, thereby enabling continuous learning and improvement of the system.

According to one embodiment herein, the data acquisition submodule collects sensor data including temperature, vibration, motion, and pressure readings. The communication layer transmits the data using secure protocols such as TLS and authenticated access. The data processing module cleans and formats the data using resampling and encoding algorithms. The model synthesis submodule uses architecture templates to construct virtual models of the physical systems. The simulation submodule executes failure modes and operational test cases to validate digital twin performance. The AI module applies predictive analytics and anomaly detection models to identify emerging issues and generate forecasts. The autonomous decision-making module evaluates optimization objectives and selects the best actions for each digital twin and for the network as a whole. The central coordination module selects the appropriate digital twins for task execution based on capability and context. The communication layer transmits decisions and receives acknowledgments from the digital twins. The user interface module allows human supervisors to view system status and perform interventions. The data storage and analysis module stores operational logs, supports model versioning, and refines algorithms using accumulated performance data.

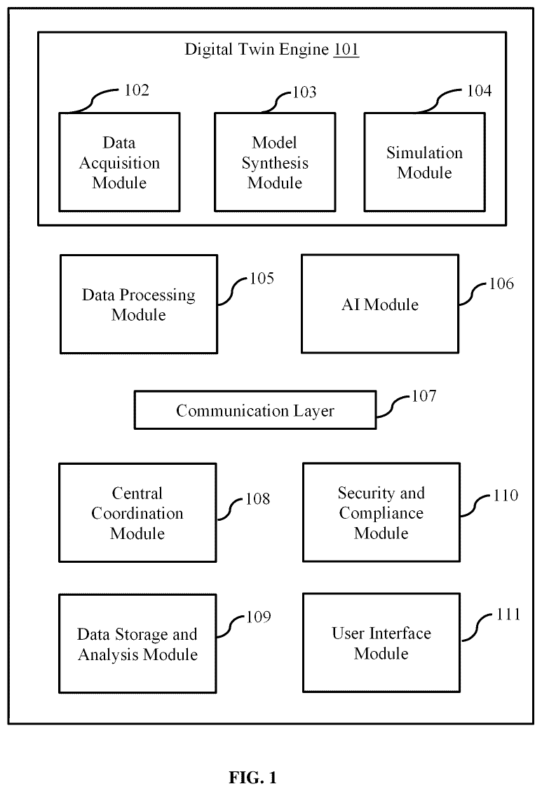

FIG. 1 illustrates the overall architecture of the system for networked digital twins with autonomous collaborative decision-making, according to one embodiment herein. The system comprises Digital Twin Engine 101, Data Acquisition Module 102, Model Synthesis Module 103, Simulation Module 104, Data Processing Module 105, AI Module 106, Communication Layer 107, Central Coordination Module 108, Data Storage and Analysis Module 109, Security and Compliance Module 110, and User Interface Module 111.

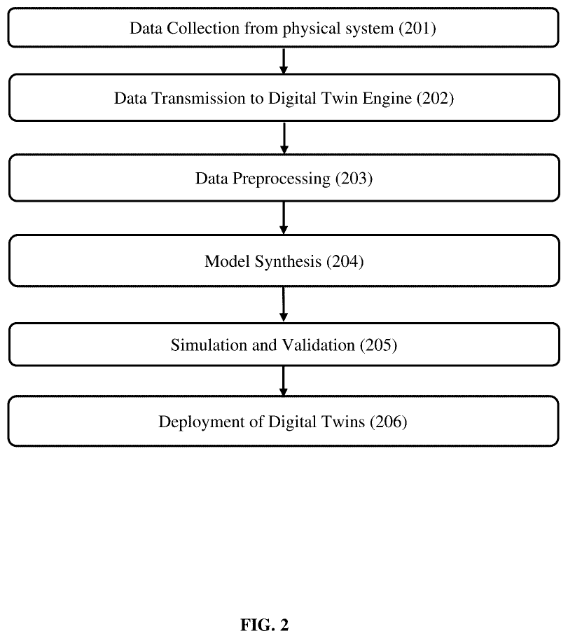

FIG. 2 illustrates a method for generating and deploying digital twins. The method comprises: Data collection from physical system (201), Data Transmission to Digital Twin Engine (202), Data Preprocessing (203), Model Synthesis (204), Simulation and Validation (205), and Deployment of Digital Twins (206).

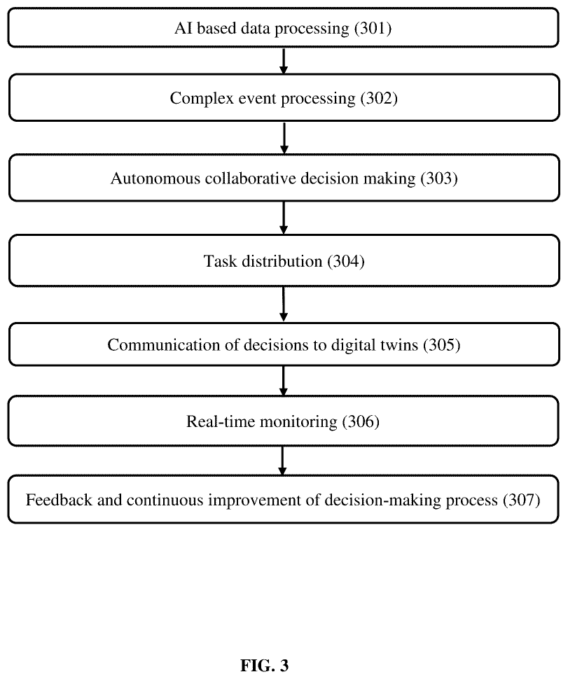

FIG. 3 illustrates a method for networking and collaboration of digital twins, according to one embodiment herein. The method comprises: AI based data processing (301), Complex event processing (302), Autonomous collaborative decision making (303), Task Distribution (304), Communication of decision to digital twins (305), Real-time monitoring (306), and Feedback and continuous improvement of decision making process (307).

The various embodiments herein provide a system and method for networked digital twins with autonomous collaborative decision-making offering several distinct advantages over existing systems and methods used for managing complex systems. The integration of AI and complex event processing allows the system to analyze data in real-time and make autonomous decisions. This capability results in immediate and accurate responses to dynamic operational conditions, significantly reducing the need for human intervention. The autonomous collaborative decision-making module enables digital twins to interact and collaborate autonomously. This collective intelligence optimizes system-wide outcomes, enhancing overall operational efficiency and reducing reliance on manual processes. The system ensures that digital twins accurately represent the physical system's architecture, functionalities, and interactions. This holistic approach provides a detailed and integrated virtual model. The modular architecture of the system facilitates the easy integration of new digital twins and expansion into various industries such as manufacturing, urban planning, and healthcare. This scalability ensures that the system can grow and adapt to different operational requirements, offering long-term usability. The integration of real-time sensor data with models ensures that digital twins maintain high fidelity and accuracy. This robust data management capability enhances the reliability and usefulness of the digital models, supporting precise monitoring and control. The feedback loop allows the system to continuously learn from operational data and improve its models and decision-making algorithms. This capability ensures that the system becomes more efficient and responsive over time, adapting to changing conditions without the need for manual recalibration. By reducing the need for manual intervention and enabling quicker, more accurate responses, the system significantly improves operational efficiency. This leads to cost savings, reduced downtime, and enhanced productivity, making it an ideal solution for managing complex systems. The system's predictive insights and advanced analytics capabilities enable proactive maintenance and optimization. This helps in anticipating potential issues before they arise, minimizing downtime, and extending the lifespan of physical assets. Additionally, the Security and Compliance Module ensures that the system adheres to industry-specific regulations and maintains robust protection against cybersecurity threats. This focus on security and compliance is crucial for safe and reliable operations across various sectors.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

It is also to be understood that the following claims are intended to cover all of the generic and specific features of the embodiments described herein and all the statements of the scope of the embodiments which as a matter of language might be said to fall there between.

What is claimed is:

1. A system for networked digital twins with autonomous collaborative decision-making, comprising:
a digital twin engine comprising a processor and a memory storing instructions that, when executed, cause the digital twin engine to: acquire real-time sensor data from a plurality of physical entities; synthesize digital models representing the physical entities including their architecture and operational parameters; and, simulate behavior of the digital models under variable operating conditions;
a data processing module implemented by a processor and configured to clean, normalize, and transform the acquired data for downstream analysis;
an artificial intelligence (AI) module comprising machine learning models and complex event processing engines configured to generate predictive insights and respond to real-time events across multiple data streams;
an autonomous collaborative decision-making module operatively coupled to the AI module and configured to synthesize outputs therefrom and compute optimized decisions for individual digital twins and a network of digital twins;
a communication layer configured to securely exchange data and decisions among digital twins and other system components using encrypted protocols;
a central coordination module comprising a task scheduler and resource allocator configured to dynamically distribute tasks across the network of digital twins based on real-time operational states;
a data storage and analysis module comprising a data repository and analytics engine configured to store operational and historical data and support predictive modeling;
a security and compliance module configured to enforce role-based access controls, data encryption, regulatory compliance, and audit logging; and
a user interface module comprising a graphical interface and reporting engine configured to enable human operators to monitor system behavior, receive alerts, and interact with the networked digital twins.

2. The system according to claim 1, wherein the digital twin engine further comprises: a data acquisition submodule configured to receive multi-modal sensor data streams in real time; a model synthesis submodule configured to construct structured digital representations of physical entities using hierarchical component definitions and dependency graphs; and, a simulation submodule configured to validate model behavior against operational rules under simulated test conditions.

3. The system according to claim 1, wherein the data processing module further comprises outlier detection algorithms, temporal alignment processors, and a schema mapping engine to prepare input data for machine learning pipelines.

4. The system according to claim 1, wherein the AI module comprises: a machine learning engine trained on historical and real-time datasets to forecast operational events; and, a complex event processing engine configured to detect predefined event patterns from streaming data.

5. The system according to claim 1, wherein the autonomous collaborative decision-making module includes a federated logic engine configured to aggregate individual digital twin decisions and compute global optimization outcomes using graph-based dependency models.

6. The system according to claim 1, wherein the communication layer supports one or more of TLS, MQTT, WebSockets, or HTTPS, and is configured to authenticate source endpoints and encrypt payloads during inter-module transmission.

7. The system according to claim 1, wherein the central coordination module includes a real-time digital twin registry and a task prioritization queue, dynamically adjusted based on twin capabilities and system state.

8. The system according to claim 1, wherein the data storage and analysis module supports structured and unstructured data ingestion, and utilizes a time-series database and a distributed file system for long-term retention.

9. The system according to claim 1, wherein the security and compliance module maintains a real-time audit trail, intrusion detection mechanisms, and compliance verification against standards including ISO 27001 and GDPR.

10. The system according to claim 1, wherein the user interface module includes dashboards for model visualization, real-time system status, alert notifications, and interfaces for parameter override and manual control.

11. A computer-implemented method for operating networked digital twins with autonomous collaborative decision-making, comprising:
collecting real-time operational data from a plurality of sensors embedded on physical systems;
transmitting the collected data to a digital twin engine via a secure communication channel;
preprocessing the received data to remove noise, align timestamps, and normalize formats for model generation;
generating digital twin models representing structural and functional aspects of the physical systems;
simulating behavior of the digital twins under multiple operational scenarios to validate accuracy;
analyzing the preprocessed data using artificial intelligence algorithms and complex event processing to extract actionable insights;
computing optimized decisions for local and network-wide operations based on the insights;
allocating tasks and operational resources across the network using central coordination logic;
transmitting decisions and commands to individual digital twins for execution;
monitoring system performance and visualizing alerts, metrics, and system states; and,
incorporating feedback into digital twin models and artificial intelligence logic for continuous learning and adaptation.

12. The method according to claim 11, wherein collecting real-time operational data is performed by a data acquisition submodule of the digital twin engine and involves real-time ingestion of sensor data from temperature, vibration, motion, and pressure sensors.

13. The method according to claim 11, wherein transmitting the collected data uses a communication layer that supports encrypted protocols including TLS and public-private key authentication, and wherein, preprocessing the received data is performed by a data processing module that applies data cleaning, resampling, and value encoding routines.

14. The method according to claim 11, wherein generating digital twin models is performed by a model synthesis submodule using system architecture templates to build virtual models, and wherein, simulating behavior of the digital twins is performed by a simulation submodule evaluating multiple fault scenarios and operating modes to assess model behavior.

15. The method according to claim 11, wherein analyzing the preprocessed data is performed by an AI module comprising predictive analytics, anomaly detection, and multi-event pattern recognition, and wherein, computing optimized decisions is performed by an autonomous collaborative decision-making module that uses an optimization algorithm combining local utility and global performance metrics.

16. The method according to claim 11, wherein allocating tasks and operational resources is performed by a central coordination module that selects digital twins for specific tasks based on availability, historical performance, and location.

17. The method according to claim 11, wherein transmitting decisions and commands involves decision packet transmission over the communication layer and acknowledgment receipt at each digital twin node, and wherein, monitoring system performance is facilitated by a user interface module comprising dashboards and manual override controls.

18. The method according to claim 11, wherein incorporating feedback is implemented by a data storage and analysis module that maintains versioned model logs and feeds updated performance metrics to an AI training pipeline.
